(19) United States
(12) Patent Application Publication
(10) Pub. No.: US 2004/0205664 A1
(43) Pub. Date: Oct. 14, 2004

(54) Claim data and document processing system

(76) Inventor: Thomas V. Prendergast, Jamison, PA (US)

Correspondence Address: Alexander J. Burke, Intellectual Property Department, 5th Floor, 170 Wood Avenue South, Iselin, NJ, 08830, US

(21) Appl. No.: 10/783,077

(22) Filed: Feb. 20, 2004

Related U.S. Application Data
(60) Provisional application No. 60/457,197, filed on Mar. 25, 2003.

(51) Int. Cl. G06F 17/21

(52) U.S. Cl. 715/530

(57) ABSTRACT

A system which processes claim data related to provision of healthcare to a patient includes the following. An interface processor receives claim data related to a claim for provision of a service to a particular patient. An attachment processor automatically applies predetermined claim submission requirements in processing the claim data to identify: (a) whether an attachment document is required to be submitted together with the claim to a payer for claim reimbursement; and (b) which particular document is to be provided together with the claim to said payer for claim reimbursement. A document processor retrieves the particular document from storage for provision to said payer for claim reimbursement.

The present Utility patent application is based on Provisional patent application No. 60/457,197, filed on Mar. 25, 2003.

### FIELD OF THE INVENTION

The present invention relates generally to the field of financial data processing, and more particularly to systems that facilitate the identification and processing of reimbursement claim data, including documentation supporting such claims.

### BACKGROUND OF THE INVENTION

Many businesses provide services to customers in which reimbursement of at least a portion of the fee for the provision of those services is expected to be paid by a third party. For example, automobile repair businesses provide repair services for the owners of automobiles. In the case of an accident, reimbursement of at least a portion of the fee for those repairs may be made by an automobile insurance company. Similarly, repairs provided by home repair companies may under some circumstances be reimbursed by the homeowner's insurance company.

To receive reimbursement from the third party, such businesses submit a claim to the third party. Each such third party requires that certain data, which may include supporting documentation, be provided to them in that claim before they will provide the reimbursement to the businesses. If all required claim data is provided, then the reimbursement will be provided to the business. However, is any required claim data is missing, then the third party will not provide reimbursement until the missing data is submitted to them.

This is also generally true for provision of medical services to patients. Most patients at doctors' offices, hospitals, dental offices or other healthcare providers have medical insurance or are the beneficiary of some form of some other third party (e.g. employer) reimbursement. The healthcare provider, in order to obtain payment for medical services rendered to a patient, assembles the data required by the third party (termed a payer) to generate a claim for reimbursement. This claim is sent to the third party payer. The payer evaluates the data in the claim and returns the payment to the healthcare provider for the rendered service. Approximately twenty percent of claims for reimbursement submitted by healthcare providers require some sort of attachment, such as a photocopy of an invoice, a lab report or an x-ray or photograph, be sent to the payer in order to complete the claim.

Prior claim filing systems have attempted to address the problem of tracking and retrieving necessary attachments by means of entirely manual processes. In these known systems, a clerk analyzes the reimbursement claim to determine which, if any, attachments are required. The clerk then retrieves the required attachments, which may reside in hardcopy form, from various file cabinets possibly at several different locations. Such manual systems require that a copy be made and sent, often by mail, to the payer as part of the completed claim request. A manual system requires substantial record keeping. In addition, in the case of healthcare services, information from different entities appears on different forms and is not formatted for ready access by others. In these cases the attachment are manually generated.

Some automated systems define sets of rules executable by software-based rules engines that prompt or query a system user concerning the need for an attachment. However, such systems only indicate the need for an attachment and do not specify the particular type of attachment that is needed or identify the specific document to be retrieved. For example, such a system may indicate that an emergency room report is required as an attachment. But the patient in question may have had several emergency room admissions. The user determines which specific desired emergency room report is required. This requires time and effort by the healthcare provider's personnel in order to identify and retrieve the necessary attachment.

Other related data processing systems link insurers to claims service providers. Using such a system, an insurer may notify the claims service provider of the need to scan report documents (e.g. photographs, video image, medical records, etc.) into digital form and then electronically attach these electronic documents to a claim file. Such systems identify the need for an attachment, but still require substantial manual intervention to actually locate, scan and transmit the desired attachment document.

Other insurance claims processing systems link claim forms, e.g. a dental claim form, to specific documentation, such as a dental x-ray. Such a system may be used in the specific situation where, for example, a dentist is required to obtain approval from an insurance company prior to performing a procedure, and the insurance company wishes to view an x-ray as part of its decision making process.

Other systems link patient information to at least one stored medical record. Such systems store medical records in an electronic format and associate those records with a particular patient. However, they do not enable users to associate needed attachments with a particular insurance claim.

In general, in existing systems, whenever claims require attachments, the claims need to be manually reviewed to determine which type of attachment, and which specific document is required. The document then needs to be located and a copy of the document retrieved. This causes a delay in the transmission of the attachment and a resultant delay in reimbursement. Attachment retrieval also increases the amount of clerical work, such as searching through file cabinets and walking to a different department to retrieve the attachments, thereby increasing provider costs. Furthermore, these attachments are often photocopied, thereby increasing the cost of copier operation related to paper and toner expenditures.

### BRIEF SUMMARY OF THE INVENTION

The inventor has realized that a need exists for a system that provides an automated method to identify and retrieve specific documents from a medical documentation database, and to attach these documents to an insurance claim form. While the system should be automated, it should also provide an opportunity for a user to intervene and inspect the attachment selection and association process, and to identify additional documentation that may be needed but which has not yet been reduced to an electronic form.

In accordance with principles of the present invention, a system which processes claim data related to provision of healthcare to a patient includes the following. An interface processor receives data related to a claim for provision of a service to a particular patient. An attachment processor automatically applies predetermined claim submission requirements in processing the claim data to identify: (a) whether an attachment document is required to be submitted together with the claim to a payer for claim reimbursement; and (b) which particular document is to be provided together with the claim to said payer for claim reimbursement. A document processor retrieves the particular document from storage for provision to said payer for claim reimbursement.

### BRIEF DESCRIPTION OF THE DRAWING

In the drawing:

FIG. 1 is a block diagram of the overall claim data processing system according to the present invention;

FIG. 2 is a more detailed block diagram of the claim data processing system of the present invention; and

FIG. 3 is a flow chart illustrating the data processing steps performed by the system illustrated in FIG. 2.

### DETAILED DESCRIPTION OF THE INVENTION

The document processing system of the present invention is a software application designed to meet the needs of different types or groups of end users in an insurance claims processing setting. Examples of different groups of users include healthcare providers, physicians, dentists, clerical workers and claims administrators.

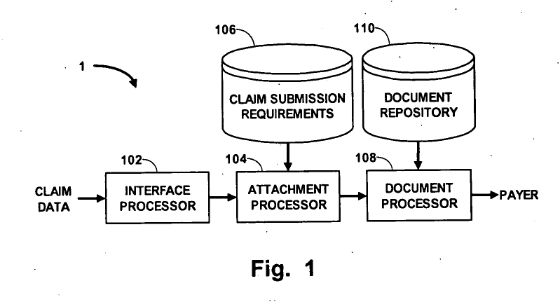

FIG. 1 is a block diagram of a claim data processing system 1 according to the present invention. In FIG. 1, claim data is assembled by the healthcare provider. The claim data is provided to an interface processor 102 which gathers and organizes the claim data in electronic form. An attachment processor 104 receives the claim data from the interface processor 102 and claim submission requirements from a storage device 106. The attachment processor 104 automatically applies the predetermined claim submission requirements 106 to the claim data to identify whether an attachment document is required with the claim to the payer for reimbursement and which particular document satisfies the requirement. The attachment may be any type of external document, such as (a) a receipt, (b) photograph, (c) chart, (d) invoice, (e) certificate, (f) prescription form or any other type of document. The attachment processor 104, thus, generates a list of attachments required by the claim. The list of attachments is supplied to a document processor 108. The list of required attachments is processed by the document processor 108 and previously stored images of the documents required to be attached to the claim are retrieved from a document repository 110. The retrieved documents are matched to the claim and are forwarded to the payer with the claim.

In operation, claim data may be assembled by any of a number of known systems, including real time entry by healthcare providers, later manual entry by data entry clerks, and/or other automated processes. Such claim assembly systems are known and any such system, which provides the required capabilities, may be used.

The claim data is then analyzed by the attachment processor 104. The claim submission requirements 106 may be represented by a set of rules which are processed one at a time. Each rule may analyze one or more fields of claim data to determine if the presence of data, absence of data and/or the value(s) of that data indicates that an attachment is required, and what document satisfies the requirement. In general, claim data fields indicate the nature of service provided to the patient. The nature of the service may determine whether an attachment is required and what document will satisfy that requirement. For example, a rule may associate claim data having particular values, indicating provision of a service of a particular nature, with an attachment and particular document.

More specifically, a payer may require receipts from a medical laboratory before reimbursing the healthcare provider for medical tests performed by the laboratory. In this example, a field in the claim data contains data that indicates that this claim includes a request for reimbursement for laboratory test expenses. A rule in the claim submission requirements 106 conditions the attachment processor 104 to examine the field in the claim data representing the type of expense, and if the value of the data in that field indicates that the type of expense is for laboratory tests, the attachment processor 104 generates data indicating: (a) that an attachment is required for this claim, and (b) that the type of document required is a receipt for the laboratory expenses. The attachment processor also produces data identifying the specific receipt in the document repository 110. This data is supplied to the document processor 108. In a similar manner, claim data indicating a request for reimbursement for medical services provided to set a broken bone may condition the attachment processor 104 to indicate that a copy of one or more X-ray images or photographs is required; a claim for reimbursement for providing medication may require a copy of a prescription; a claim for reimbursement for healthcare services provided by an outside healthcare organization may require a copy of a receipt; and so forth.

In the illustrated embodiment, the document processor 108 is implemented as a document management system. A document management system is a database for documents. Documents are kept in a document repository 110 in electronic form, e.g. word processing, spreadsheet, images or any other appropriate file format for documents. Records are kept for each document in the document repository 110 which include data fields used to identify, among other things, where the document is stored in the document repository 110, the date and time of the document, a set of keywords used to classify the document, which parties are related to the document (such as the patient, doctor, outside provider in the case of a medical testing laboratory) and other important information. These records may be searched by users and used in locating documents in the document repository 110. The document management system also includes the capability of automatically locating and retrieving documents from the document repository in response to automated requests. In the illustrated embodiment, the document processor 108 uses the data from the attachment processor 104 automatically to locate the required attachment documents in the document repository 110, to retrieve the document and to forward the electronic file representing that document to the payer. Such document management systems are known and any such systems, which provide the required capabilities, may be used.

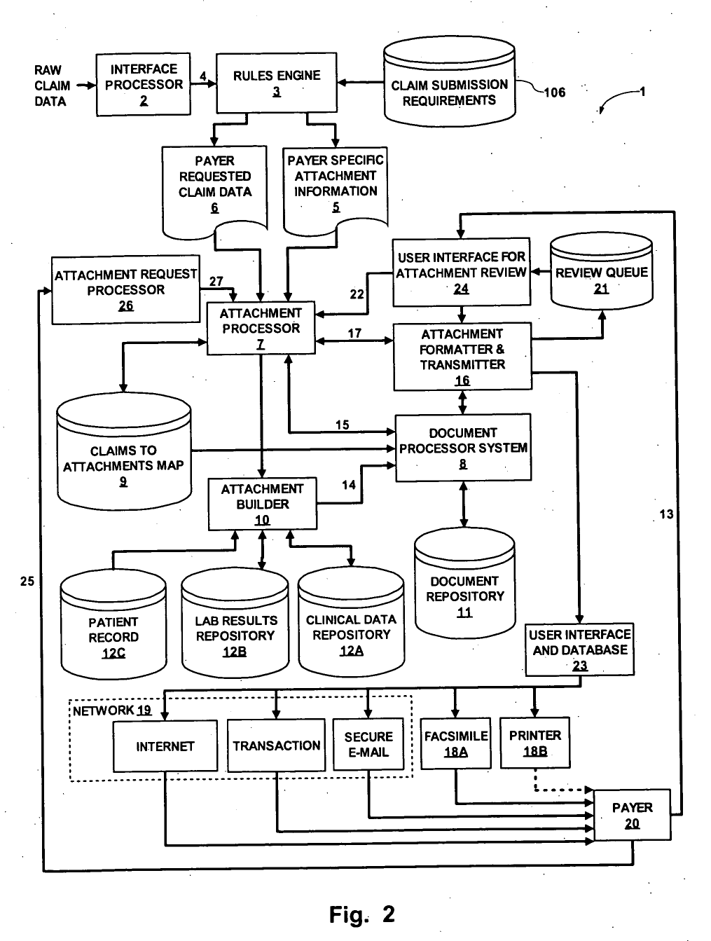

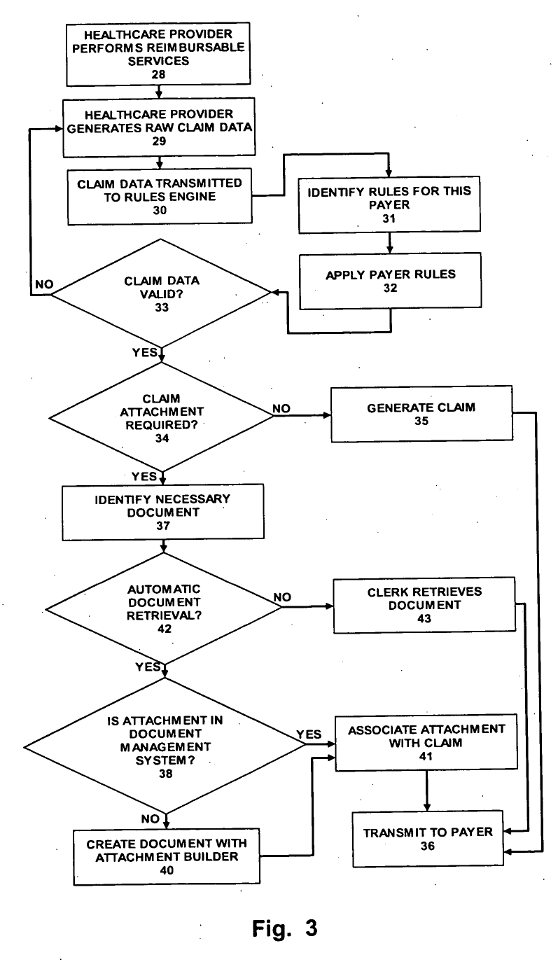

FIG. 2 is a more detailed block diagram of a claim data processing system and FIG. 3 is a flowchart illustrating the operation of the system illustrated in FIG. 1. These two figures are referred to simultaneously in the following description. As seen in FIG. 2, the claim data processing system 1 is seen to include an interface processor 2 for receiving raw claim data. This data may contain information identifying the patient, his insurance policy, services performed for the patient by the healthcare provider and the costs associated with those services. Referring to FIG. 3, regardless of the nature of the claim data 2, the system 1 begins at step 28 when the healthcare or other service provider performs some service that is reimbursable by a payer 20. The claim data 2 is produced at step 29 by a compatible claim data processor or external data generation system as is known.

The claim data 2 is sent via path 4 to a rules engine 3 at step 30, either as a batch file residing in a predetermined storage or memory location, or in response to a direct call by the rules engine 3 through a dedicated rules engine application programming interface (API). The rules engine 3 has access to the claim submission requirements 106 for the payers to which claims are sent by this healthcare provider. The claim submission requirements 106 are in the form of a set of rules to be applied to the claim data. At step 31 the rules engine 3 identifies the subset of the rules that are applicable to the specific payer 20 who is expected to reimburse the claim currently being processed, and at step 32 applies this subset of rules to the claim data. Application of these rules permit the rules engine 3 to determine, at step 33, if the claim appears to be valid, that is, if required data is present and if that data has values appropriate for the claim. If not, the process returns to step 29 in search of the required raw claim data that is missing or invalid.

As described above with respect to FIG. 1, the submission requirements rules 106 also include rules that identify whether an attachment is required. If the claim is valid, a determination of whether an attachment is required is made at step 34 by applying those submission requirements rules 106. If no attachment is required, the claim may be generated immediately at step 35. If an attachment is required, the rules engine 3 may further generate information 5 for identifying the document that the particular payer 20 requires as an attachment based on rules relating to diagnosis, procedure, charge information and/or other payer 20 requested claim data 6 contained in the claim.

The payer 20 requested claim data 6 and any attachment information 5 that is generated is forwarded to a software subroutine called the attachment processor 7. At step 37, the attachment processor 7 operates to determine which document or documents, are required to be attached to the claim. In cases where several versions of a document exist, the attachment processor 7 determines which version of the document is required. If attachment information 5 is present, the attachment processor 7 scans this data to identify which documents are required. If there is no attachment information 5, the attachment identifier 7 processes the claim data 6 to identify what documents are required. In this case, the attachment processor 7 processes the claim data 6 to derive information including at least one of (a) diagnosis information, (b) medical procedure information, (c) charge information, and/or other such information related to the claim, and employs the derived information to identify which documents are required to be submitted with the claim to a payer for claim reimbursement.

At step 42 an inquiry is made as to whether the identified documents are to be retrieved manually or automatically. The direction to retrieve attachment documents automatically or manually may be made by asking a system user for each claim, or may be set to a desired default setting. Alternatively, a check may be made to determine if the required document is in the document management system. If so, then automatic document retrieval may be specified. If not, then manual document retrieval is specified.

If the attachments are to be retrieved manually, a clerk intervenes and obtains the desired documents at step 43. In this case, the clerk manually accesses the document processor system 8, which may be implemented as a document management system, to locate the required documents. If documents are not in the document processor system 8, the clerk enters them into the document processor system 8. If the documents do not exist in any form, the clerk generates them and enters them in the document management system 8.

If the attachments are to be retrieved automatically, at step 42 the attachment processor 7 communicates document description information via path 15 to the document processor system 8 in order to automatically locate each document or the desired version of each document in the document repository 11. If the desired document is found in the document repository 11 the document management system 8 returns information specifying the location of the document to the attachment processor 7. The attachment processor 7 then updates, at step 41, a claims-to-attachments map 9 which correlates or associates the current claim with the location of each of the documents required to be attached to the claim. In the illustrated embodiment, the claims-to-attachments map 9 contains a record for each identified document containing, among other things, data representing the location of the document and the claim to which that document is attached. If there is any ambiguity as to which document is to be attached to the claim, this ambiguity is noted in another data field in the appropriate record in the claims-to-attachment map 9. Handling of ambiguously identified documents is described below.

If the required document is not found in the document repository 11 by the document processor system 8, or if the attachment processor 7 determines that an attachment containing more data is required, the attachment processor 7 invokes the attachment builder 10 at step 40. The attachment builder 10 can communicate with a clinical data repository 12A, a laboratory results repository 12B and/or an electronic patient record 12C in order to gather the appropriate information needed to dynamically construct a document representing the required attachment. The dynamically constructed document is automatically stored in the document processor system 8 via path 14, and data representing the location of the dynamically constructed document is returned to the attachment processor 7 via path 15. The attachment processor 7 updates the claims-to-attachments map 9 with this data, as described above with respect to documents already in the document processor system 8.

For each claim, the attachment processor 7 transmits document location representative data from the claim-to-attachments map 9 to an attachment formatter and transmitter subroutine 16 via path 17 for the attachments related to that particular claim. The attachment formatter and transmitter subroutine 16 then retrieves the identified documents from the document management system 8. If necessary, the attachment formatter and transmitter subroutine 16 formats the documents as appropriate according to the specifications of the payer 20.

In those cases where a clerk manually retrieves attachment documents (step 43) or where the claims-to-attachments map 9 indicates no ambiguity as to which documents are required and available, the documents are ready to send to the payer 20. Configuration settings specifying the method transmission of the claim and attachments to the payer 20 are set via a user interface and database 23 associated with the attachment formatter and transmitter 16. For example, claims and attachments may be sent to the payer 20 electronically, on paper, or a combination of these methods, such as by facsimile.

When the system 1 is configured for automatic electronic data transmission, the locations of the attachment documents for the claim being transmitted are retrieved from the claims-to-attachment map 9 and provided to the attachment formatter and transmitter 16. The necessary document(s) are then retrieved in electronic form from the document repository 11 by the document processor 8, and are formatted for transmission to the payer 20 by the attachment formatter and transmitter 16. The claim and attachments are prepared for transmission by the user interface and database 23.

The claim and attachments may be forwarded electronically to the payer 20 by employing any desired transmission method, such as facsimile 18A via phone lines, or by electronic data network connection 19, such as by secure electronic mail, by a transaction standard compatible communication, or by any other internet compatible communication method that meets the needs of the particular healthcare provider and payer 20. When data network communications 19 is used, the electronic attachment documents may be encrypted before transmission, to ensure they are unreadable except to authorized receivers. In addition, when electronic mail 19 is used for claim and attachment transmission, secure enveloping technology is preferably employed prior to or during the transmission to ensure that only the intended recipient 20 can access the data. The attachment formatter and transmitter 16 may control the transmission, or it may use an intermediary, including the document management system 8, to perform the transmission. It is also possible to simply print the documents (and claim) on a printer 18B and forward them to the payer 20 via standard mail, as indicated by a dashed line in FIG. 2.

If the claims-to-attachments map 9 indicates an ambiguity in one or more of the attachment documents required for a particular claim, or if the system 1 is configured to review the attachments, the attachment formatter and transmitter 16 makes an entry in the review queue 21 instead of transmitting the attachments to the payer 20 via the user interface and database 23. This entry indicates that a claim and attachments require human review. This entry contains data which identifies the claim, the claim data and the data representing the attachments, including data indicating any ambiguously identified document. A user interface for attachment review 24 allows a reviewer to see any entries which exist in the review queue 21, to select a claim in the queue to review, and to review the claim data and attachments related to the selected entry. The reviewer may approve the transmission of the attachments as they are presented, or may manually choose other attachments for transmission via the document management system 8. If the reviewer selects different attachments, this information may be sent as feedback 22 to the attachment processor 7, which, in turn, updates the appropriate entries in the claims-to-attachments map 9.

When attachment feedback 22 is provided by the user interface for attachment review 24, the user interface 24 also allows the reviewer to revise such feedback 22 or to manually generate feedback 22. In a similar manner, the payer 20 may provide feedback on the accuracy of the attachments which were transmitted to it via path 13. Such feedback is supplied to the user interface for attachment review 24. The reviewer reviews this feedback and forwards it to the attachment processor 7 via path 22 to permit improvement of the attachment identification algorithms so that better automatic attachment matching can be attained.

It is also possible for the payer 20 to send a request via path 25 either for further information in the form of additional attachments, or for required attachments which were not included with the claim. In response to such a request an attachment request processor subroutine 26 invokes the attachment processor 7 via path 27, to locate and/or generate any necessary claim and attachment information, and to forward that information to the payer 20, in the manner described above. Attachment requests from the payer 20 may also be sent to the attachment review user interface 24 via path 13, which may be used as described above to optimize the operation of the attachment processor 7.

The present invention has been described above in relation to a system for processing claim data related to provision of healthcare services to a patient. However, one skilled in the art will understand that this system may be used in any business in which services are rendered to a customer, and the service provider must file a claim for reimbursement which may possibly require predetermined documentation to be attached.

The embodiment of the present invention described above is illustrative and exemplary only, and is not the only possible embodiment of the present invention. Other embodiments in accordance with principles of the present invention are possible.

What is claimed is:

1. A system for processing claim data related to provision of healthcare to a patient, comprising:
an interface processor for receiving claim data related to a claim for provision of a service to a particular patient;
an attachment processor for automatically applying predetermined claim submission requirements in processing said claim data to identify:
whether an attachment document is required to be submitted together with said claim to a payer for claim reimbursement; and
a particular document to be provided together with said claim to said payer for claim reimbursement; and
a document processor for retrieving said particular document from storage for provision to said payer for claim reimbursement.

2. A system according to claim 1, wherein said document processor automatically initiates communication of said particular document to said payer by electronic communication including at least one of, (a) Facsimile transmission, (b) Email, (c) Internet compatible communication and (d) a transaction standard compatible communication.

3. A system according to claim 2, wherein said electronic communication includes encryption of said particular document prior to communication.

4. A system according to claim 1, wherein said attachment processor automatically identifies a particular version of said particular document to be provided together with said claim to said payer for claim reimbursement.

5. A system according to claim 1, wherein said attachment processor automatically identifies a particular type of said particular document to be provided together with said claim to said payer for claim reimbursement.

6. A system according to claim 5 wherein said particular type includes one of (a) a receipt, (b) a photograph, (c) a chart, (d) an invoice, (e) a certificate, and (f) a prescription.

7. A system according to claim 1, wherein said attachment processor processes said claim data to derive information including at least one of (a) diagnosis information, (b) medical procedure information and (c) charge information, related to said claim, and employs said derived information in determining whether an attachment document is required to be submitted together with said claim to a payer for claim reimbursement.

8. A system according to claim 1, wherein said document processor determines said particular document is unavailable from storage and initiates generation of said particular document.

9. A system according to claim 8, wherein said document processor determines said particular document is unavailable from storage and initiates generation of said particular document using information derived from at least one of, (a) a clinical data repository, (b) a laboratory results repository and (c) an electronic patient record of said particular patient.

10. A system according to claim 1, wherein said attachment processor compiles a map associating a particular claim with one or more required attachments and updates said map in response to identifying said particular document is to be provided together with said claim to said payer for claim reimbursement.

11. A system according to claim 10 wherein said predetermined claim submission requirements comprise rules which associate claim data indicating provision of a service of a particular nature with an attachment and particular document.

12. A system according to claim 11 wherein said predetermined claim submission requirements comprise rules which associated one of more of: (a) a laboratory receipt with a claim for reimbursement for a laboratory test; (b) an X-ray with a claim for reimbursement for setting a broken bone; (c) a prescription with a claim for reimbursement for providing medication; a receipt with a claim for reimbursement for services provided by an outside organization.

13. A system according to claim 1, wherein;
said attachment processor automatically applies said predetermined claim submission requirements in processing said claim data to identify a plurality of documents to be provided together with said claim to said payer for claim reimbursement, and
said document processor retrieves said plurality of documents from storage for provision to said payer for claim reimbursement.

14. A system for processing data related to receiving reimbursement for provision of a service to a customer, comprising:
an interface processor for receiving data related to a claim for reimbursement for provision of a service to a customer;
an attachment processor for automatically applying predetermined claim submission requirements in processing said claim data to identify:
whether an attachment document is required to be submitted together with said claim to a payer for claim reimbursement; and
a particular document to be provided together with said claim to said payer for claim reimbursement; and
a document processor for retrieving said particular document from storage for provision to said payer for claim reimbursement.

15. A method for processing claim data related to provision of healthcare to a patient, comprising the steps of:
receiving claim data related to a claim for provision of a service to a particular patient;
processing said claim data by automatically applying predetermined claim submission requirements for the purpose of:
identifying whether an attachment document is required to be submitted together with said claim to a payer for claim reimbursement; and
identifying a particular document to be provided together with said claim to said payer for claim reimbursement; and
retrieving said particular document from storage for provision to said payer for claim reimbursement.

16. The method of claim 13 further comprising the step of automatically initiating communication of said particular document to said payer by electronic communication including at least one of, (a) Facsimile transmission, (b) Email, (c) Internet compatible communication and (d) a transaction standard compatible communication.

17. The method of claim 14 further comprising the step of encrypting said particular document before initiating communication.

18. The method of claim 13 wherein the step of identifying a particular document comprises the step of identifying a particular version of the particular document.

19. The method of claim 13 wherein the step of identifying a particular document comprises the step of identifying a particular type of the particular document.

20. The method of claim 17 wherein the step of identifying a particular type of the particular document comprises identifying the particular type as one of (a) a receipt, (b) a photograph, (c) a chart, (d) an invoice, (e) a certificate, and (f) a prescription.

21. The method of claim 13 wherein the steps of:
processing said claim data comprises the step of deriving information including at least one of (a) diagnosis information, (b) medical procedure information and (c) charge information, related to said claim; and
employing said derived information to determine whether an attachment document is required to be submitted together with said claim to a payer for claim reimbursement.

22. The method of claim 13 wherein the step of retrieving said particular document comprises the steps of:
determining if said particular document is available in said storage; and
generating said particular document if said particular document is not available is said storage.

23. The method of claim 20 wherein the step of generating said particular document comprises the steps of:
deriving information from at least one of (a) a clinical data repository, (b) a laboratory results repository and (c) an electronic patient record of said particular patient; and
generating said particular document using the derived information.

24. The method of claim 13 wherein the step of processing said claim data comprises the steps of:
compiling a map associating a particular claim with one or more required attachments; and
updating said map in response to identifying said particular document is to be provided together with said claim to said payer for claim reimbursement.

25. The method of claim 13 wherein the step of processing said claim data comprises the steps of:
automatically applying said predetermined claim submission requirements in processing said claim data for the purpose of identifying a plurality of documents to be submitted together with said claim to said payer for claim reimbursement, and
retrieving said plurality of documents from storage for provision to said payer for claim reimbursement.

26. A method for processing data related to provision of a service to a customer, comprising the steps of:
receiving data related to a claim for provision of a service to a particular customer;
processing said data by automatically applying predetermined claim submission requirements for the purpose of:
identifying whether an attachment document is required to be submitted together with said claim to a payer for claim reimbursement; and
identifying a particular document to be provided together with said claim to said payer for claim reimbursement; and
retrieving said particular document from storage for provision to said payer for claim reimbursement.
